(19) United States
(12) Patent Application Publication
(10) Pub. No.: US 2021/0388226 A1
(43) Pub. Date: Dec. 16, 2021

(54) DYE SUBLIMATION INKJET INK SET

(71) Applicant: Hewlett-Packard Development Company, L.P., Spring, TX (US)

(72) Inventors: Kai-Kong Iu, San Diego, CA (US); Zhang-Lin Zhou, San Diego, CA (US); Hector Lebron, San Diego, CA (US)

(73) Assignee: Hewlett-Packard Development Company, L.P., Spring, TX (US)

(21) Appl. No.: 17/417,484

(22) PCT Filed: Jul. 12, 2019
(86) PCT No.: PCT/US2019/041673

§ 371 Date: Jun. 23, 2021

(30) Foreign Application Priority Data
Feb. 4, 2019 (US) PCT/US2019/016485

(51) Int. Cl. C09D 11/328; C09D 11/40; D06P 1/00; D06P 3/54; D06P 5/30; D06P 5/28; B41M 5/00

(52) U.S. Cl. CPC C09D 11/328; C09D 11/40; D06P 1/0012; B41M 5/0047; D06P 5/30; D06P 5/004; D06P 3/54

(57) ABSTRACT

An example dye sublimation inkjet ink set includes a first dye sublimation inkjet ink and a second dye sublimation inkjet ink. The first dye sublimation inkjet ink includes a disperse dye colorant dispersion including a first disperse dye having absorption at a radiation wavelength ranging from about 360 nm to about 410 nm; an additive to absorb energy at the radiation wavelength ranging from about 360 nm to about 410 nm and to dissipate at least some of the absorbed energy as fluorescence; a co-solvent; and a balance of water. The additive is selected from the group consisting of a compound containing from 3 to 5 fused benzene rings and and a coumarin derivative. The second dye sublimation inkjet ink includes a disperse dye colorant dispersion including a second disperse dye having less absorption at the radiation wavelength than the first disperse dye; a co-solvent; and a balance of water.

### CROSS-REFERENCE TO RELATED APPLICATIONS

This application claims priority to International Application Serial Number PCT/US2019/016485, filed Feb. 4, 2019, the content of which is incorporated by reference herein in its entirety.

### BACKGROUND

Textile printing methods often include rotary and/or flat-screen printing. Traditional analog printing typically involves the creation of a plate or a screen, i.e., an actual physical image from which ink is transferred to the textile. Both rotary and flat screen printing have great volume throughput capacity, but also have limitations on the maximum image size that can be printed. For large images, pattern repeats are used. Conversely, digital inkjet printing enables greater flexibility in the printing process, where images of any desirable size can be printed immediately from an electronic image without pattern repeats. Inkjet printers, and in particular piezoelectric inkjet printers, are gaining rapid acceptance for digital textile printing. Inkjet printing is a non-impact printing method that utilizes electronic signals to control and direct droplets or a stream of ink to be deposited on media.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating two examples of a printing method; and

FIGS. 2A through 2C depict black and white reproductions of originally colored photographs of example and comparative prints on polyester after UV energy exposure.

### DETAILED DESCRIPTION

The textile market is a major industry, and printing on textiles, such as cotton, polyester, etc., may be performed using dye sublimation. Some dye sublimation printing techniques involve thermal transfer, where the dye sublimation ink is first printed onto a transfer medium. The printed transfer medium is then pressed against the desired textile and is heated (e.g., using a heated calendering roller), which transfers the dye from the transfer paper to the textile. The heat sublimates the dye, allowing the dye to migrate into the fibers of the textile. While this process may render printed textiles with desired color attributes and durability performance, the thermal transfer portion of the process can be economically and/or energy inefficient, can reduce print-job throughput, and can increase the complexity of the overall printing process.

In contrast, the examples disclosed herein do not involve a thermal transfer process. Rather, in the examples disclosed herein, a dye sublimation inkjet ink can be directly printed onto the textile substrate. The printed ink is exposed to radiation having a wavelength ranging from about 360 nm to about 410 nm, resulting in rapid and localized heat generation within the textile fibers to drive colorant sublimation.

Some examples of the dye sublimation inkjet ink include a disperse dye colorant dispersion (e.g., a cyan disperse dye colorant dispersion or a magenta disperse dye colorant dispersion) that can absorb radiation at wavelengths ranging from about 360 nm to about 410 nm. Other examples of the dye sublimation inkjet ink include a disperse dye colorant dispersion (e.g., a yellow disperse dye colorant dispersion or a black disperse dye colorant dispersion) that absorbs more of such radiation. These examples of the dye sublimation inkjet ink include an additive to absorb energy at the radiation wavelength ranging from about 360 nm to about 410 nm and to dissipate at least some of the absorbed energy as fluorescence. Because the additive dissipates at least some of the absorbed energy as fluorescence rather than heat, the additive may prevent the printed textile substrate from overheating and thus becoming heat damaged. The examples of the dye sublimation inkjet ink including the disperse dye colorant dispersion that absorb less of the radiation do not include the energy dissipating additive. Thus, when a print is generated with both an example of the dye sublimation inkjet ink including the disperse dye colorant dispersion that absorbs more of the radiation and an example of the dye sublimation inkjet ink including the disperse dye colorant dispersion that absorbs less of the radiation, both the dye sublimation inkjet inks may sublime under the same radiation exposure conditions without damaging printed textile substrate.

The examples disclosed herein render printed textile substrates with desired color attributes and durability performance, while also providing a simpler and efficient dye sublimation printing technique that does not involve a transfer medium, a heated calendering roller, sequential print and heating sequences for different colors, etc.

Throughout this disclosure, a weight percentage that is referred to as “wt % active” or “wt % actives” refers to the loading of an active component of a dispersion or other formulation that is present in the dye sublimation inkjet ink. For example, the disperse dye may be present in a water-based formulation (e.g., a dispersion) before being incorporated into the inkjet ink. In this example, the wt % actives of the dye accounts for the loading (as a weight percent) of the dye that is present in the inkjet ink composition, and does not account for the weight of the other components (e.g., water, etc.) that are present in the formulation with the dye. The term “wt %,” without the term actives, refers to either i) the loading (in the inkjet ink or other composition) of a 100% active component that does not include other non-active components therein, or ii) the loading (in the inkjet ink or another composition) of a material or component that is used “as is” and thus the wt % accounts for both active and non-active components.

Dye Sublimation Inkjet Inks

The dye sublimation inkjet inks disclosed herein exhibit light absorption efficiency at the wavelength(s) used for dye sublimation.

In some examples, the dye sublimation inkjet ink is a first dye sublimation inkjet ink that includes an additive that absorbs and dissipates some of the dye sublimation radiation. An example of the first dye sublimation inkjet ink includes: a first disperse dye colorant dispersion including a first disperse dye having absorption at a radiation wavelength ranging from about 360 nm to about 410 nm; an additive to absorb energy at the radiation wavelength ranging from about 360 nm to about 410 nm and to dissipate at least some of the absorbed energy as fluorescence, the additive being selected from the group consisting of a compound containing from 3 to 5 fused benzene rings and a coumarin derivative; a first co-solvent; and a balance of water. In some examples, the first dye sublimation inkjet ink consists of these components, and thus does not include any other components. In other examples, the first dye sublimation inkjet ink may include other additives, such as a surfactant, a chelating agent, a buffer, an antimicrobial agent, and combinations thereof.

In other examples, the dye sublimation inkjet ink is a second dye sublimation inkjet ink that includes a colorant (disperse dye) that absorbs less of the dye sublimation radiation (e.g., than the first dye sublimation inkjet ink disclosed herein), and thus, the additive is not included in the ink composition. An example of the second dye sublimation inkjet ink includes: a second disperse dye colorant dispersion including a second disperse dye having less absorption at the radiation wavelength than the first disperse dye; a second co-solvent; and a balance of water. The second dye sublimation inkjet ink does not include the additive. In some examples, the second dye sublimation inkjet ink consists of these components, and thus does not include any other components. In other examples, the second dye sublimation inkjet ink may include other additives, such as a surfactant, a chelating agent, a buffer, an antimicrobial agent, and combinations thereof.

In some examples, the first dye sublimation inkjet ink is a yellow dye sublimation inkjet ink or a black dye sublimation inkjet ink; and the second dye sublimation inkjet ink is a cyan dye sublimation inkjet ink or a magenta dye sublimation inkjet ink.

It is to be understood that the designations “first”, “second”, etc., as applied herein to dye sublimation inkjet inks, disperse dye colorant dispersions, co-solvents, etc., do not designate a particular order, but rather are added as identifiers in order to clearly refer to particular compositions or components.

The composition of the dye sublimation inkjet ink depends, in part, upon the molecular structure of the dye in the ink, and the extent to which the dye absorbs the wavelength of light used for dye sublimation. Examples of the different dye sublimation inkjet inks disclosed herein will now be described in more detail.

First Dye Sublimation Inkjet Inks

As mentioned herein, examples of the first dye sublimation inkjet ink disclosed herein include: the first disperse dye colorant dispersion including the first disperse dye having absorption at a radiation wavelength ranging from about 360 nm to about 410 nm; the additive to absorb energy at the radiation wavelength ranging from about 360 nm to about 410 nm and to dissipate at least some of the absorbed energy as fluorescence, the additive being selected from the group consisting of a compound containing from 3 to 5 fused benzene rings and a coumarin derivative; the first co-solvent; and the balance of water.

First Disperse Dye Colorant Dispersions

Each disperse dye colorant dispersion includes a disperse dye, a dispersant, and a dispersion vehicle. In examples of the first dye sublimation inkjet ink, it is to be understood that the first disperse dye in the first disperse dye colorant dispersion absorbs enough of the radiation (e.g., having a wavelength ranging from about 360 nm to about 410 nm) to undergo sublimation. In an example, the absorption/absorbance exhibited by the first disperse dye at the desirable wavelength may be greater than 0.7 (where absorbance (A) is calculated by A=εcL, in which ε is the molar extinction coefficient and is >1000 M⁻¹ cm⁻¹, c is the molar concentration, and L is the light path length in cm).

While the first disperse dye may be any color, it has been found that black disperse dyes and yellow disperse dyes may be particularly suitable for use with the additive in the first dye sublimation inkjet ink. As such, in some examples, the first disperse dye colorant dispersion is a black disperse dye colorant dispersion or a yellow disperse dye colorant dispersion.

Black disperse dye colorant dispersions often include a blend of disperse dyes, such as, for example, blends of blue, brown and yellow disperse dyes, or blends of blue, orange and violet disperse dyes, or blends of blue, orange and yellow disperse dyes, or blue, magenta, and yellow dyes. An example of a suitable blue, brown and yellow disperse dye blend include disperse blue 360 (DB360), disperse brown 27, and disperse yellow 54 (DY54). Some examples of suitable blue, orange and violet disperse dye blends include disperse blue 291:1 (DB291:1), disperse orange 29 (D029) and disperse violet 63, or DB291:1, D029 and disperse violet 99. An example of a suitable blue, orange and yellow dye blend includes DB360, disperse orange 25, and DY54. An example of a suitable blue, magenta, and yellow dye blend includes disperse blue 77 (DB77), disperse red 92, and disperse yellow 114 (DY 114).

Yellow disperse dye colorant dispersions may include yellow disperse dyes, such as DY54, disperse yellow 64, disperse yellow 71, disperse yellow 86, DY114, disperse yellow 153, disperse yellow 233, disperse yellow 245, and mixtures thereof.

The first disperse dye colorant dispersion may include from about 10 wt % dye solids to about 20 wt % dye solids based on the total weight of the first disperse dye colorant dispersion.

As mentioned, each disperse dye colorant dispersion also includes a dispersant. The dispersant may be any suitable polymeric dispersant that can disperse the dye and that can be jetted via a thermal or piezoelectric inkjet printhead.

Some examples of the polymeric dispersant include polymers or copolymers of acrylics, methacrylics, acrylates, methacrylates, styrene, substituted styrene, α-methylstyrene, substituted α-methyl styrenes, vinyl naphthalenes, vinyl pyrollidones, maleic anhydride, vinyl ethers, vinyl alcohols, vinyl alkyls, vinyl esters, vinyl ester/ethylene copolymers, acrylamides, and/or methacrylam ides. Some specific examples include a styrene methacrylic acid copolymer, a styrene acrylic acid copolymer, styrene acrylic acid-acrylic ester copolymers, styrene methacrylic acid-acrylic ester copolymers, a styrene maleic anhydride copolymer, polyacrylic acid partial alkyl ester, polyalkylene polyamine, polyacrylates, and vinyl naphthalene-maleic acid copolymers. Another example of a suitable polymeric dispersant is a polyurethane polymer. Still other examples of suitable polymeric dispersants for the disperse dye colorant dispersion include block acrylic copolymers, including A-B block copolymers such as benzyl methacrylate-methacrylic acid diblock copolymers and butyl methacrylate-methacrylic acid diblock copolymers. Still further examples of suitable polymeric dispersants include ABC triblock copolymers, such as benzyl methacrylate-methacrylic acid-ethoxytriethyleneglycol methacrylate triblock copolymers and butyl methacrylate-methacrylic acid-ethoxytriethyleneglycol methacrylate triblock copolymers. Still some other examples of suitable dispersants include low acid value acrylic resins, such as JONCRYL® 586, 671, 675, 678, 680, 683, 690, 693, and 695 (from BASF Corp.).

Examples of polymerization methods used to form the dispersant may include free radical processes, Group Transfer Processes (GTP), radical addition fragmentation (RAFT), atom transfer reaction (ATR), special chain transfer polymerization technology (SCT), and the like. As one example, the dispersant may be a graft acrylic copolymer made by SCT.

In other examples, the disperse dyes may be self-dispersing dyes. The disperse dyes may be exposed to a diazonium treatment (where a charged free radical from a degraded azo attaches to the colorant), or to an ozone treatment (oxidation and functionalization with, e.g., a carboxylic acid), or to a crosslinking treatment to render the dye self-dispersing.

The first disperse dye colorant dispersion may include from about 4 wt % dispersant solids to about 7 wt % dispersant solids, based on the total weight of the first disperse dye colorant dispersion.

The mean particle size of the solids (e.g., the disperse dyes and the dispersants) in the first disperse dye colorant dispersion may range from about 50 nm to about 100 nm. In another example, the mean particle size of the first disperse dye ranges from about 100 nm to about 200 nm. These particle sizes (which may be volume-weighted mean diameters) are particularly suitable for being jetted through the orifices of thermal or piezo inkjet printheads.

The dispersion vehicle may include water and a water soluble or water miscible co-solvent. Examples of the water soluble or water miscible co-solvent in the first disperse dye colorant dispersion may include alcohols (e.g., diols, such as 1,2-propanediol, 1,3-propanediol, etc.), ketones, ketoalcohols, ethers (e.g., the cyclic ether tetrahydrofuran (THF), and others, such as thiodiglycol, sulfolane, 2-pyrrolidone, 1-(2-hydroxyethyl-2-pyrrolidone, 1,3-dimethyl-2-imidazolidinone and caprolactam; glycols such as ethylene glycol, diethylene glycol, tritriethylene glycol, tetraethylene glycol, propylene glycol, dipropylene glycol, tripropylene glycol, trimethylene glycol, butylene glycol, and hexylene glycol; addition polymers of oxyethylene or oxypropylene such as polyethylene glycol, polypropylene glycol and the like; triols such as glycerol and 1,2,6-hexanetriol; lower alkyl ethers of polyhydric alcohols, such as ethylene glycol monomethyl ether, ethylene glycol monoethyl ether, diethylene glycol monomethyl, and diethylene glycol monoethyl ether; and lower dialkyl ethers of polyhydric alcohols, such as diethylene glycol dimethyl or diethyl ether.

One or more of these co-solvents may be present in the first disperse dye colorant dispersion in respective amounts ranging from about 1 wt % to about 5 wt %, based on the total weight of the first disperse dye colorant dispersion. The balance of the first disperse dye colorant dispersion is water, such as purified water or deionized water.

In an example, the first disperse dye colorant dispersion has i) a mean particle size ranging from about 50 nm to about 200 nm, and ii) from about 10 wt % dye solids to about 20 wt % dye solids and from about 4 wt % to about 7 wt % dispersant solids, based on the total weight of the first disperse dye colorant dispersion. In this example, the remainder of the first disperse dye colorant dispersion may be co-solvent(s) and water.

The first disperse dye colorant dispersion may be added to the other ink components (e.g., the additive, the first co-solvent, and the balance of water) such that the first disperse dye colorant dispersion is present in an amount ranging from about 1 wt % actives to about 15 wt % actives, based on a total weight of the first dye sublimation inkjet ink. In another example, the first disperse dye colorant dispersion may be present in an amount ranging from about 3 wt % actives to about 10 wt % actives, based on the total weight of the first dye sublimation inkjet ink. The wt % actives of the first disperse dye colorant dispersion accounts for the loading (as a weight percent) of the active dye solids present in the ink, and does not account for the weight of the other components (e.g., co-solvent, water, etc.) of the first disperse dye colorant dispersion in the first dye sublimation inkjet ink.

Energy Dissipating Additives

The first dye sublimation inkjet ink also includes the additive that is capable of absorbing energy at the radiation wavelength ranging from about 360 nm to about 410 nm and dissipating at least some of the absorbed energy as fluorescence. By dissipating at least some of the absorbed energy as fluorescence rather than heat, the additive may prevent a print (that is generated using the first dye sublimation inkjet ink) from becoming heat damaged.

The additive has absorbance at the radiation wavelength ranging from about 360 nm to about 410 nm. The phrase “having absorption” or “has absorbance,” when used in combination with this additive means that at least 5% of radiation having wavelengths within the specified range is absorbed by the additive. The absorbed radiation or energy may cause the additive to enter an excited state.

In some example, absorbance (A) may be calculated by A=εcL, in which c is the molar extinction coefficient, c is the molar concentration, and L is the light path length in cm.

In some examples, the additive has an extinction coefficient (ε) greater than 1,000 M⁻¹ cm⁻¹. In other examples, the extinction coefficient (ε) of the additive is greater than 5,000 M⁻¹ cm⁻¹, greater than 10,000 M⁻¹ cm⁻¹, or greater than 20,000M⁻¹ cm⁻¹. In still other examples, the extinction coefficient (ε) of the additive is about 5,000 M⁻¹ cm⁻¹, about 7,000 M⁻¹ cm⁻¹, about 9,000 M⁻¹ cm⁻¹, about 10,000 M⁻¹ cm⁻¹, about 12,000 M⁻¹ cm⁻¹, or about 20,000 M⁻¹ cm⁻¹. These extinction coefficients may be at the radiation wavelength ranging from about 360 nm to about 410 nm. In one example, these extinction coefficients may be at the radiation wavelength of 395 nm.

The additive then dissipates at some of the absorbed radiation or energy as fluorescence. As used herein, “fluorescence” refers to the emission of radiation having a wavelength ranging from 360 nm to 700 nm. Because the wavelength(s) of the radiation fluoresced by the additive is 700 nm or less, the radiation is not emitted as heat energy. In some examples, the wavelength of the emitted radiation may be longer than the wavelength of the absorbed radiation.

In some examples, a fluorescence lifetime of the additive is less than 20 nano-seconds (ns) in a particular solvent. For example, a fluorescence lifetime of the compound containing from 3 to 5 fused benzene rings is less than 20 ns in cyclohexane; or a fluorescence lifetime of the coumarin derivative is less than 20 ns in polymethylmethacrylate (PMMA). In other examples, the fluorescence lifetime of the additive may be less than 15 ns, less than 10 ns, or less than 5 ns in ethanol, cyclohexane, or polymethylmethacrylate. In still other examples, the fluorescence lifetime of the additive may be about 2.67 ns, about 3.3 ns, about 5.3 ns, about 5.8 ns, about 6.4 ns, about 7.2 ns, about 8.19 ns, or about 9.35 ns in ethanol, cyclohexane, or polymethylmethacrylate. As used herein, “fluorescence lifetime” refers to the amount of time the additive spends in the excited state before emitting the radiation having the wavelength ranging from 360 nm to 700 nm.

In some examples, a fluorescence yield of the additive is greater than 0.55 in a particular solvent. For example, a fluorescence yield of the compound containing from 3 to 5 fused benzene rings is greater than 0.5 in cyclohexane; or a fluorescence lifetime of the coumarin derivative is greater than 0.7 in polymethylmethacrylate. In some other examples, a fluorescence yield of the additive is greater than 0.8 in ethanol, cyclohexane, or polymethylmethacrylate. In still other examples, the fluorescence yield of the additive is greater than 0.69, greater than 0.79, greater than 0.85, greater than 0.9, or greater than 0.95 in ethanol, cyclohexane, or polymethylmethacrylate. In still other examples, the fluorescence yield is about 0.81, about 0.9, about 0.94, or about 0.95, or about 1.0 in ethanol, cyclohexane, or polymethylmethacrylate. As used herein, “fluorescence yield” refers to the ratio of the amount of radiation emitted to the amount of radiation absorbed.

In some examples, the additive has a fluorescence lifetime of less than 20 ns and a fluorescence yield of greater than 0.8. In some examples, the fluorescence lifetime and/or the fluorescence yield of the additive may be measured when the additive is in ethanol.

The additive is selected from the group consisting of a compound containing from 3 to 5 fused benzene rings and a coumarin derivative. In some examples, the additive is the compound containing from 3 to 5 fused benzene rings. In some of these examples, the compound containing from 3 to 5 fused benzene rings is selected from the group consisting of 9,10-diphenylanthracene, 9-(p-vinylphenyl)-10-phenylanthracene, 9,10-bis(phenylethynyl)anthracene, 1,3,6,8-tetraphenylpyrene, 10-ethoxybenzoxanthene, pyrene, perylene, chrysene, and combinations thereof. In one example, the additive is 9,10-diphenylanthracene. In other examples, the additive is the coumarin derivative. In some of these examples, the coumarin derivative is selected from the group consisting of 7-dialkylamino-3-carbaldehyde coumarin and 7-diarylamino-3-caraldehyde coumarin. In one example, the additive is 7-dimethylamino-3-carbaldehyde coumarin.

The characteristics of some of the example additives are shown in Table 1. It is to be understood that the characteristics shown in Table 1 may vary slightly in different solvents. For example, the characteristics of 9,10-diphenyl anthracene are slightly different when measured in cyclohexane and when measured in ethanol).

TABLE 1

| | | | Extinction |
|---|---|---|---|
| | Fluorescence | | coefficient |
| | lifetime | Fluorescence | at 395 nm |
| Compound | (ns) | yield | (M⁻¹cm⁻¹) |
| 9,10-diphenyl anthracene | 8.19 in ethanol | 0.95 in ethanol | 11708 |
| 9,10-diphenyl anthracene | 9.35 in | 1.0 in | 12000 |
| | cyclohexane | cyclohexane | |
| 9-(p-Vinylphenyl)-10- | 5.8 in | 1.0 in | 12000 |
| phenyl anthracene | cyclohexane | cyclohexane | |
| 9-10-Bis(phenyl-ethynyl)- | 5.3 in | 1.0 in | 7000 |
| anthracene | cyclohexane | cyclohexane | |
| 1,3,6,8-Tetraphenyl | 2.67 in | 0.9 in | 20000 |
| pyrene | cyclohexane | cyclohexane | |
| 10-Ethoxy-benzo | 7.2 in | 0.9 in | 10000 |
| xanthene | cyclohexane | cyclohexane | |
| Perylene | 6.4 in | 0.94 in | 9000 |
| | cyclohexane | cyclohexane | |
| 7-dimethylamino-3- | 3.3 ± 0.2 ns in | 0.81 ± 0.12 in | ~5000 |
| carbaldehyde coumarin | PMMA | PMMA | |

The kinetics of fluorescence quenching of the additive support the notion that the additive disclosed herein dissipates the absorbed radiation as fluorescence rather than heat. For example, the kinetics of fluorescence quenching of may be determined from equation 1.

$$1 \text{/} {T}_{f} = 1 \text{/} {T}_{f 0} + {k}_{q} [ {}_{-}^{3}{O}{}_{2}^{ } ] \qquad ( eq . 1 )$$

where T_{f0} is the natural fluorescence lifetime of the additive in a solvent, T_{f} is the measured fluorescence lifetime under quenching, k_{q} is the quenching rate constant (diffusion-limited, i.e., ˜10¹⁰M⁻¹s⁻¹), and [³O₂] is the ground state (triplet) oxygen concentration (e.g., 10⁻⁴M for water at ambient temperature). With the respective fluorescence lifetime numbers set forth in Table 1, it is clear that the second term in equation 1 is relatively insignificant. This indicates that most if not all of the absorbed energy is dissipated by the additive as fluorescence.

The low value of the second term, k_{q}[³_O₂], also indicates that the formation of singlet oxygen when generating a print with the first dye sublimation inkjet ink is minimal due, in part, to the short fluorescence lifetime of the additive and the low availability of oxygen during inkjet printing.

In some examples, the additive is present in the first dye sublimation inkjet ink in an amount ranging from about 0.025 wt % to about 2.0 wt % of a total weight of the first dye sublimation inkjet ink. In other examples, the additive is present in the first dye sublimation inkjet ink in an amount ranging from about 0.1 wt % to about 1.0 wt % of the total weight of the first dye sublimation inkjet ink. In still other examples, the additive is present in the first dye sublimation inkjet ink in an amount ranging from about 0.2 wt % to about 0.75 wt % of the total weight of the first dye sublimation inkjet ink. In yet other examples, the additive is present in the first dye sublimation inkjet ink in an amount ranging from about 0.025 wt % to about 0.25 wt % of the total weight of the first dye sublimation inkjet ink. In one specific example, the additive may be present in the first dye sublimation inkjet ink in an amount of about 0.25 wt % of the total weight of the first dye sublimation inkjet ink. In another example, the additive may be present in the first dye sublimation inkjet ink in an amount of about 0.5 wt % of the total weight of the first dye sublimation inkjet ink.

Ink Vehicles

In addition to the first disperse dye colorant dispersion and the additive, the first dye sublimation inkjet ink also includes a first co-solvent and a balance of water.

The first co-solvent(s) may be present in the first dye sublimation inkjet ink in an amount ranging from about 4 wt % to about 30 wt % (based on the total weight of the first dye sublimation inkjet ink). Examples of co-solvents include alcohols, aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like.

Specific examples of alcohols may include ethanol, isopropyl alcohol, butyl alcohol, and benzyl alcohol. The co-solvent may also be a polyhydric alcohol or a polyhydric alcohol derivative. Examples of polyhydric alcohols may include ethylene glycol, diethylene glycol, propylene glycol, dipropylene glycol, butylene glycol, triethylene glycol, 1,5-pentanediol, 1,2-hexanediol, 1,2,6-hexanetriol, 1,2-butanediol, 1,2-propanediol, 1,3-propanediol, glycerin (glycerol), trimethylolpropane, and xylitol. Examples of polyhydric alcohol derivatives may include an ethylene oxide adduct of diglycerin. The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine. Other specific co-solvent examples include tripropylene glycol methyl ether, tripropylene glycol n-butyl ether, 2-ethyl-2-(hydroxymethyl)-1,3-propane diol (EPHD), 2-methyl-1,3-propanediol, dimethyl sulfoxide, and/or sulfolane. In one specific example, the co-solvent includes glycerol. In another specific example, the co-solvent includes glycerol, ethoxylated glycerol, and optionally a water soluble or water miscible organic solvent (the latter of which may be contributed from the disperse dye colorant dispersion). In still another example, the co-solvent includes glycerol, ethoxylated glycerol, 2-methyl-1,3-propanediol, dipropylene glycol, and combinations thereof.

It is to be understood that water is present in addition to the first co-solvent(s) and makes up a balance of the first dye sublimation inkjet ink. As such, the weight percentage of the water present in the first dye sublimation inkjet ink will depend, in part, upon the weight percentages of the other components. The water may be purified or deionized water.

Some examples of the first dye sublimation inkjet ink may also include one or more additional additives that are often used in inkjettable inks. Examples of suitable additional additives include a surfactant, a chelating agent, a buffer, an antimicrobial agent, and combinations thereof.

In an example, the total amount of surfactant(s) in the first dye sublimation inkjet ink ranges from about 0 wt % to about 2 wt % (with respect to the weight of the first dye sublimation inkjet ink). In another example, the surfactant is present in an amount of 1 wt % or less. The surfactant(s) may be included in the first dye sublimation inkjet ink to aid in jettability, control the viscosity, to improve the lubricity, and/or to prevent agglomeration of the dispersed dye solids. Examples of suitable surfactants include oleth-3-phosphate, non-ionic, low foaming surfactants, such as ethoxylated 2,4,7,9-tetramethyl 5 decyn-4,7-diol (commercially available as SURFYNOL® 465 (HLB 13) from Evonik Industries) and other ethoxylated surfactants (commercially available as SURFYNOL® 440 (HLB 8) from Evonik Industries), or secondary alcohol ethoxylates (commercially available as TERGITOL® 15-S-7 (HLB 12.1), TERGITOL® 15-S-9 (HLB 12.6), etc. from The Dow Chemical Co.). In an example, the surfactant is oleth-3-phosphate, ethoxylated 2,4,7,9-tetramethyl 5 decyn-4,7-diol, or combinations thereof.

The chelating agent is another example of an additional additive that may be included in the first dye sublimation inkjet ink. When included, the chelating agent is present in an amount greater than 0 wt % actives and less than 0.1 wt % actives based on the total weight of the first dye sublimation inkjet ink. In an example, the chelating agent is present in an amount ranging from about 0.04 wt % actives to about 0.08 wt % actives based on the total weight of the first dye sublimation inkjet ink.

In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na₃MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

In an example, the pH of the first dye sublimation inkjet ink ranges from about 4 to about 10 at the time of manufacture. In another example, the pH of the first dye sublimation inkjet ink ranges from about 6.5 to about 8.5 at the time of manufacture. A pH adjuster, such as a buffer, may be added to the first dye sublimation inkjet ink to counteract any slight pH drop that may occur over time. The pH may drop from about 0.5 units to about 1 unit over time after being manufactured. As such, the pH of the inks disclosed herein may be lower or higher than the ranges set forth herein, depending, in part, upon how much time has passed since manufacture. In an example, the total amount of buffer(s) in the first dye sublimation inkjet ink ranges from 0 wt % to about 0.5 wt % (with respect to the weight of the first dye sublimation inkjet ink). In another example, the total amount of buffer(s) in the first dye sublimation inkjet ink is about 0.1 wt % (with respect to the weight of the first dye sublimation inkjet ink).

Examples of some suitable buffers include TRIS (tris(hydroxymethyl)aminomethane or Trizma), bis-tris propane, TES (2-[(2-Hydroxy-1,1-bis(hydroxymethyl)ethyl)amino]ethanesulfonic acid), MES (2-ethanesulfonic acid), MOPS (3-(N-morpholino)propanesulfonic acid), HEPES (4-(2-hydroxyethyl)-1-piperazineethanesulfonic acid), DIPSO (3-(N,N-Bis[2-hydroxyethyl]amino)-2-hydroxypropanesulfonic acid), Tricine (N-[tris(hydroxymethyl)methyl]glycine), HEPPSO (β-Hydroxy-4-(2-hydroxyethyl)-1-piperazinepropanesulfonic acid monohydrate), POPSO (Piperazine-1,4-bis(2-hydroxypropanesulfonic acid) dihydrate), EPPS (4-(2-Hydroxyethyl)-1-piperazinepropanesulfonic acid, 4-(2-Hydroxyethyl)piperazine-1-propanesulfonic acid), TEA (triethanolamine buffer solution), Gly-Gly (Diglycine), bicine (N,N-Bis(2-hydroxyethyl)glycine), HEPBS (N-(2-Hydroxyethyl)piperazine-N′-(4-butanesulfonic acid)), TAPS ([tris(hydroxymethyl)methylamino]propanesulfonic acid), AMPD (2-amino-2-methyl-1,3-propanediol), TABS (N-tris(Hydroxymethyl)methyl-4-aminobutanesulfonic acid), or the like.

In an example, the total amount of antimicrobial agent(s) in the first dye sublimation inkjet ink ranges from about 0 wt % actives to about 0.5 wt % actives (with respect to the total weight of the first dye sublimation inkjet ink). In another example, the total amount of antimicrobial agent(s) in the first dye sublimation inkjet ink composition ranges from about 0.001 wt % actives to about 0.1 wt % actives (with respect to the total weight of the first dye sublimation inkjet ink).

Examples of suitable antimicrobial agents include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

Second Dye Sublimation Inkjet Inks

As mentioned herein, examples of the second dye sublimation inkjet ink disclosed herein include: the second disperse dye colorant dispersion including a second disperse dye having less absorption at the radiation wavelength than the first disperse dye; the second co-solvent; and the balance of water. As also mentioned herein, in some examples, the second dye sublimation inkjet ink excludes the energy dissipating additive in the first dye sublimation inkjet ink.

Second Disperse Dye Colorant Dispersions

In examples of the second dye sublimation inkjet ink, it is to be understood that the second disperse dye in the second disperse dye colorant dispersion absorbs enough of the radiation (e.g., having a wavelength ranging from about 360 nm to about 410 nm) to undergo sublimation. In an example, the absorption/absorbance exhibited by the second disperse dye at the desirable wavelength may be less than 0.2 (where absorbance (A) is calculated by A=εcL, in which c is the molar extinction coefficient and is >1000 M⁻¹ cm⁻¹, c is the molar concentration, and L is the light path length in cm).

While the second disperse dye may be any color, it has been found that cyan disperse dyes and magenta disperse dyes may be particularly suitable for use in the second dye sublimation inkjet ink without the energy dissipating additive. As such, in some examples, the second disperse dye colorant dispersion is a cyan disperse dye colorant dispersion or a magenta disperse dye colorant dispersion. As specific examples, cyan disperse dyes (in the cyan disperse dye colorant dispersion) may include blue disperse dyes, such as disperse blue 27, disperse blue 60, disperse blue 73, disperse blue 77, disperse blue 87, disperse blue 257, disperse blue 291:1, disperse blue 359, disperse blue 360, disperse blue 367, and mixtures thereof. Magenta disperse dyes (in the magenta disperse dye colorant dispersion) may include red disperse dyes, such as disperse red 60, disperse red 82, disperse red 86, disperse red 86:1, disperse red 167:1, disperse red 279, and mixtures thereof.

The second disperse dye colorant dispersion may include from about 10 wt % dye solids to about 20 wt % dye solids based on the total weight of the second disperse dye colorant dispersion.

The second disperse dye colorant dispersion may also include any of the dispersant(s) along with any example of the dispersion vehicle disclosed herein in reference to the first disperse dye colorant dispersion.

The second disperse dye colorant dispersion may be added to the other ink components (e.g., the second co-solvent, and the balance of water) such that the second disperse dye colorant dispersion is present in an amount ranging from about 1 wt % actives to about 15 wt % actives, based on a total weight of the second dye sublimation inkjet ink. In another example, the second disperse dye colorant dispersion may be present in an amount ranging from about 3 wt % actives to about 10 wt % actives, based on the total weight of the second dye sublimation inkjet ink. The wt % actives of the second disperse dye colorant dispersion accounts for the loading (as a weight percent) of the active dye solids present in the ink, and does not account for the weight of the other components (e.g., co-solvent, water, etc.) of the second disperse dye colorant dispersion in the second dye sublimation inkjet ink.

Ink Vehicles

In addition to the second disperse dye colorant dispersion, the second dye sublimation inkjet ink a second co-solvent and a balance of water.

The second co-solvent(s) may be present in the second dye sublimation inkjet ink in an amount ranging from about 4 wt % to about 30 wt % (based on the total weight of the second dye sublimation inkjet ink). Examples of the second co-solvent include any of the co-solvent(s) disclosed herein in reference to the first dye sublimation inkjet ink.

It is to be understood that water is present in addition to the second co-solvent(s) and makes up a balance of the second dye sublimation inkjet ink. As such, the weight percentage of the water present in the second dye sublimation inkjet ink will depend, in part, upon the weight percentages of the other components. The water may be purified or deionized water.

Some examples of the second dye sublimation inkjet ink may also include one or more additional additives that are often used in inkjettable inks. Examples of suitable additives include a surfactant, a chelating agent, a buffer, an antimicrobial agent, and combinations thereof. Any of the surfactant(s), chelating agent(s), buffer(s), and/or antimicrobial agent(s) described herein in reference to the first dye sublimation inkjet ink may be used in second dye sublimation inkjet ink in any of the amounts described herein (except the amounts are based on the total weight of the second dye sublimation inkjet ink rather than the first dye sublimation inkjet ink).

Dye Sublimation Inkjet Ink Sets

The first and second dye sublimation inkjet inks disclosed herein may be included in an ink set.

In an example, the dye sublimation inkjet ink set comprises: (i) a first dye sublimation inkjet ink including: a first disperse dye colorant dispersion including a first disperse dye having absorption at a radiation wavelength ranging from about 360 nm to about 410 nm; an additive to absorb energy at the radiation wavelength ranging from about 360 nm to about 410 nm and to dissipate at least some of the absorbed energy as fluorescence, the additive being selected from the group consisting of a compound containing from 3 to 5 fused benzene rings and a coumarin derivative; a first co-solvent; and a balance of water; and (ii) a second dye sublimation inkjet ink including: a second disperse dye colorant dispersion including a second disperse dye having less absorption at the radiation wavelength than the first disperse dye; a second co-solvent; and a balance of water. In one example of the ink set, the second dye sublimation inkjet ink excludes the additive (i.e., energy dissipating additive) in the first dye sublimation inkjet ink.

In another example, the dye sublimation inkjet ink set comprises: (i) a first dye sublimation inkjet ink including: a first disperse dye colorant dispersion including a first disperse dye having absorption at a radiation wavelength ranging from about 360 nm to about 410 nm; an additive to absorb energy at the radiation wavelength ranging from about 360 nm to about 410 nm and to dissipate at least some of the absorbed energy as fluorescence, the additive being selected from the group consisting of a compound containing from 3 to 5 fused benzene rings and a coumarin derivative; a first co-solvent; and a balance of water; and (ii) a second dye sublimation inkjet ink consisting of: a second disperse dye colorant dispersion including a second disperse dye having less absorption at the radiation wavelength than the first disperse dye; optionally, another additive selected from the group consisting of a surfactant, a chelating agent, a buffer, an antimicrobial agent, and combinations thereof; a second co-solvent; and a balance of water.

It is to be understood that any example of the first dye sublimation inkjet ink may be used in the examples of the dye sublimation inkjet ink set. It is also to be understood that any example of the second dye sublimation inkjet ink may be used in the examples of the dye sublimation inkjet ink set.

In one example of the ink set, the first dye sublimation inkjet ink is a yellow dye sublimation inkjet ink or a black dye sublimation inkjet ink; and the second dye sublimation inkjet ink is a cyan dye sublimation inkjet ink or a magenta dye sublimation inkjet ink. In another example of the ink set, the first dye sublimation inkjet ink is a yellow dye sublimation inkjet ink; the second dye sublimation inkjet ink a cyan dye sublimation inkjet ink; and the ink set further includes a black dye sublimation inkjet ink (which includes the additive to absorb energy at the radiation wavelength ranging from about 360 nm to about 410 nm and to dissipate at least some of the absorbed energy as fluorescence, the additive being selected from the group consisting of a compound containing from 3 to 5 fused benzene rings and a coumarin derivative) and a magenta dye sublimation inkjet ink (which does not include the energy dissipating additive).

When the inks of these example ink sets are printed together, each of the different inks may sublime under the same radiation exposure conditions without damaging the printed textile substrate, e.g., due to the energy dissipating additive in some of the ink(s) (e.g., the first ink). As such, the radiation exposure may be the same for the entire print, regardless of the inks used to generate the print.

Textile Substrates

In the examples disclosed herein, the dye sublimation inkjet ink(s) may be printed on any suitable textile substrate. In an example, the textile fabric is selected from the group consisting of polyester, polyester blends, and polyester coated substrates. In another example, the textile fabric is selected from the group consisting of polyester and polyester blends. Polyester blends may include polyester in combination with one or more other material(s). One example of a polyester blend is a polyester-cotton blend. An example of a tri-blend includes cotton, polyester and spandex. Polyester coated substrates may include a polyester coated metal sheet, a polyester coated ceramic, etc.

It is to be understood that organic textile fabrics and/or inorganic textile fabrics may be used for the textile fabric. Some types of fabrics that can be used include various fabrics of natural and/or synthetic fibers.

Example natural fiber fabrics that can be used in polyester blends include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in polyester blends can include polymeric fibers such as nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., KEVLAR®, E.I. du Pont de Nemours and Company) polytetrafluoroethylene (TEFLON®, The Chemours Co.), fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

It is to be understood that the terms “textile fabric,” “textile substrate,” or “fabric substrate” do not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles (e.g., clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

Textile Printing Kits

The textile substrate and the first dye sublimation inkjet ink disclosed herein may be included in a textile printing kit.

In an example, the textile printing kit comprises: a textile fabric; and a dye sublimation inkjet ink including: a first disperse dye colorant dispersion including a first disperse dye having absorption at a radiation wavelength ranging from about 360 nm to about 410 nm; an additive to absorb energy at the radiation wavelength ranging from about 360 nm to about 410 nm and to dissipate at least some of the absorbed energy as fluorescence, the additive being selected from the group consisting of a compound containing from 3 to 5 fused benzene rings and a coumarin derivative; a co-solvent; and a balance of water.

In some examples, the textile printing kit further comprises: a second dye sublimation inkjet ink including: a second disperse dye colorant dispersion including a second disperse dye having less absorption at the radiation wavelength than the first disperse dye; a second co-solvent; and a balance of water. Examples of the second dye sublimation inkjet ink exclude the energy dissipating additive that is present in the first dye sublimation inkjet ink.

In one of these examples, the first dye sublimation inkjet ink is a yellow dye sublimation inkjet ink or a black dye sublimation inkjet ink; and the second dye sublimation inkjet ink is a cyan dye sublimation inkjet ink or a magenta dye sublimation inkjet ink.

It is to be understood that any example of the first dye sublimation inkjet ink may be used in the examples of the textile printing kit. It is also to be understood that any example of the second dye sublimation inkjet ink may be used in the examples of the textile printing kit. Further, it is to be understood that any example of the textile fabric may be used in the examples of the textile printing kit. In one specific example of the textile printing kit, the textile fabric is selected from the group consisting of polyester, polyester blends, and polyester coated substrates.

Printing Methods

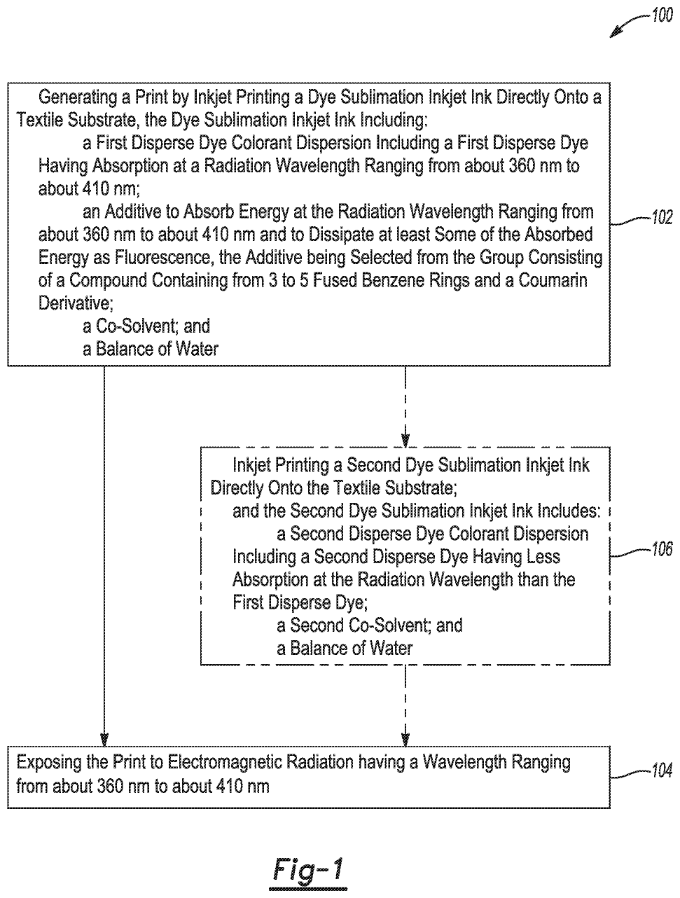

FIG. 1 depicts two examples of the printing method 100.

As shown in FIG. 1, one example of the printing method 100 comprises: generating a print by inkjet printing a dye sublimation inkjet ink directly onto a textile substrate, the dye sublimation inkjet ink including: a first disperse dye colorant dispersion including a first disperse dye having absorption at a radiation wavelength ranging from about 360 nm to about 410 nm; an additive to absorb energy at the radiation wavelength ranging from about 360 nm to about 410 nm and to dissipate at least some of the absorbed energy as fluorescence, the additive being selected from the group consisting of a compound containing from 3 to 5 fused benzene rings and a coumarin derivative; a co-solvent; and a balance of water (reference numeral 102); and exposing the print to electromagnetic radiation having a wavelength ranging from about 360 nm to about 410 nm (reference numeral 104).

Also as shown in FIG. 1, in another example of the printing method 100, the generating of the print further includes inkjet printing a second dye sublimation inkjet ink directly onto the textile substrate; and the second dye sublimation inkjet ink includes: a second disperse dye colorant dispersion including a second disperse dye having less absorption at the radiation wavelength than the first disperse dye; a second co-solvent; and a balance of water (reference numeral 106).

It is to be understood that any example of the first dye sublimation inkjet ink may be used in the examples of the printing method 100. It is also to be understood that any example of the second dye sublimation inkjet ink may be used in the examples of the printing method 100. Further, it is to be understood that any example of the textile substrate may be used in the examples of the printing method 100. In one specific example of the printing method 100, the textile substrate is selected from the group consisting of polyester, polyester blends, and polyester coated substrates.

The dye sublimation inkjet ink(s) may be inkjet printed onto the textile substrate using any suitable inkjet applicator, such as a thermal inkjet printhead, a piezoelectric printhead, a continuous inkjet printhead, etc. The inkjet applicator may eject dye sublimation inkjet ink(s) in a single pass or in multiple passes. As an example of single pass printing, the cartridge(s) of an inkjet printer deposit the desired amount of the ink during the same pass of the cartridge(s) across the substrate. In other examples, the cartridge(s) of an inkjet printer deposit the desired amount of the ink composition over several passes of the cartridge(s) across the substrate.

In the examples of the method 100, the exposure of the print to electromagnetic radiation having a wavelength ranging from about 360 nm to about 410 nm may be accomplished with a radiation source. In an example, the radiation source may be a light emitting diode having an emission wavelength ranging from 360 nm to about 410 nm. In another example, the radiation source may be a narrow wavelength ultraviolet light source. In still another example of the method 100, the exposing of the print is accomplished with a narrow wavelength ultraviolet light source having an emission wavelength of 365 nm, 375 nm, 385 nm, 395 nm or 405 nm. In yet another example, the radiation source may be a 395 nm light emitting diode.

In the examples of the method 100, the exposure of the print to electromagnetic radiation having a wavelength ranging from about 360 nm to about 410 nm may take place for an amount of time sufficient to raise a temperature of the print so that the disperse dye(s) in the print is/are sublimated. In an example, the exposing of the print to the radiation wavelength may be for a time period ranging from about 0.1 seconds to about 20 seconds. In another example, the exposing of the print to the radiation wavelength may be for a time period ranging from about 0.1 seconds to about 5 seconds.

The radiation exposure takes place very rapidly with the radiation source. To avoid overheating, it may be desirable to adjust the settings of the radiation source. For example, either example of the method 100 may include setting the radiation source to a power setting ranging from about 3.5 W/cm² to about 10 W/cm². The power setting may depend, in part, upon the light source used, the total time for exposure, the distance between the light source and the substrate, etc. Higher power settings may be desirable for faster throughput systems. In another example, the energy (radiant) exposure ranges from about 0.5 J/cm² to about 20 J/cm². In a specific example, if a power of 10 W/cm² is applied for 1 second, the applied energy is 10 J/cm².

In one example, the exposing of the print to electromagnetic radiation is for a time period ranging from about 0.1 sec to about 5 sec; and the electromagnetic radiation results in an energy exposure ranging from about 0.5 J/cm² to about 20 J/cm².

The temperature at which sublimation takes place depends upon the disperse dye(s) that is/are used. In some examples, the radiation exposure may raise the temperature of the print to between about 150° C. and about 210° C., or between about 180° C. and about 220° C. It is to be understood that if the sublimation temperature of a selected ink were 200° C., the temperature to which the fabric (having the print thereon) is raised may be any suitable temperature at or slightly above (e.g., +5° C.) 200° C.

It is to be understood that the exposing of the print to the radiation wavelength may be accomplished using a single continuous pulse exposure of radiation, or a multiple pulsing mode of radiation exposure. As such, in some examples, the exposing of the print to electromagnetic radiation includes a single exposing event; and, in other examples, the exposing of the print to electromagnetic radiation includes multiple exposing events. Multiple exposing events including multiple radiation pulses, where the exposure time during each of the individual pulses of radiation may be added to calculate a total exposure time. Examples of this total exposure time fall within the example time period ranges disclosed above.

In some examples, both of the first and second dye sublimation inkjet inks disclosed herein are used to generate a print. In these examples and when the printed-on textile substrate is exposed to the radiation wavelength ranging from about 360 nm to about 410 nm, the first disperse dye of the first dye sublimation inkjet ink, the additive of the first dye sublimation inkjet ink, and the second disperse dye of the second dye sublimation inkjet ink each absorb some of the energy. The first and second disperse dyes absorb some of the applied radiation, which heats the dyes up to their sublimation temperatures. Energy absorption and subsequent heating causes the dyes to sublimate and migrate into the textile substrate material (e.g., fibers of the textile fabric). The dyes then re-solidify on the textile substrate, which renders the printed image durable and in some instances wash-resistant and colorfast. The additive also absorbs some of the applied radiation, but unlike the dyes, the additive dissipates at least some of the absorbed energy as fluorescence. This prevents the first disperse dye from absorbing too much of the applied radiation, generating too much heat, and damaging the printed textile substrate.

To further illustrate the present disclosure, an example is given herein. It is to be understood that this example is provided for illustrative purposes and is not to be construed as limiting the scope of the present disclosure.

This example illustrates that the addition of the energy dissipating additive to a dye sublimation ink with a high absorbing disperse dye reduces and/or prevents heat damage to printed textile substrates. Moreover, the generated prints have a desirable optical density and washfastness. Washfastness can be measured in terms of optical density (OD) stability. The term “optical density stability,” as referred to herein, means that the degree to which the printed image absorbs incident rays of light remains substantially unchanged after the printed image is washed. To determine the optical density stability of a print, the change in optical density may be measured before and after washing the print, and the percentage of optical density change may be determined. The optical density may be considered to be “substantially unchanged after being washed” when the percentage of optical density change is 10% or less.

### EXAMPLE

Two examples of the first dye sublimation inkjet ink disclosed herein (ex. ink 1 and ex. ink 2) were prepared. A comparative example of the first dye sublimation inkjet ink (comp. ink) was also prepared. The example energy dissipating additive included in each of the example inks was 9,10-diphenylanthracene. The comparative ink did not include the energy dissipating additive.

The general formulation of each of the inks is shown in Table 2, with the wt % active of each component that was used.

TABLE 2

| | | Ex. ink | Ex. ink | Comp. |
|---|---|---|---|---|
| Ingredient | Specific Component | 1 | 2 | ink |
| Disperse | Yellow disperse dye | 3.7 | 3.7 | 3.7 |
| dye colorant | colorant dispersion | | | |
| dispersion | | | | |
| Energy | 9,10- | 0.25 | 0.5 | — |
| Dissipating | diphenylanthracene | | | |
| Additive | | | | |
| Co-solvent | Glycerol | 12 | 12 | 12 |
| | Ethoxylated Glycerol | 4 | 4 | 4 |
| Surfactant | SURFYNOL ® 465 | 0.5 | 0.5 | 0.5 |
| Chelating | TRILON ® M | 0.04 | 0.04 | 0.04 |
| Agent | | | | |
| Buffer | TRIS | 0.1 | 0.1 | 0.1 |
| Biocide | ACTICIDE B20 | 0.0045 | 0.0045 | 0.0045 |
| | ACTICIDE M20 | 0.0095 | 0.0095 | 0.0095 |
| Water | Deionized water | Balance | Balance | Balance |

Several prints were generated by thermal inkjet printing the ink compositions on polyester fabric. No pre-treatment was performed on the fabric before generating the prints.

A 395 nm light emitting diode (Hereaus lamp) was used to perform dye sublimation on the different print samples. The power percentage, at which the LED lamp was operated, was varied to produce different amounts of UV energy exposure. The prints were exposed to 6.62 J/cm² of UV energy, 8.275 J/cm² of UV energy, or 9.93 J/cm² of UV energy.

All of the prints exposed to 6.62 J/cm² of UV energy (i.e., the print generated with ex. ink 1, the print generated with ex. ink 2, and the print generated with the comp. ink) did not have heat damage. All of the prints exposed to 8.275 J/cm² of UV energy (i.e., the print generated with ex. ink 1, the print generated with ex. ink 2, and the print generated with the comp. ink) did not have heat damage.

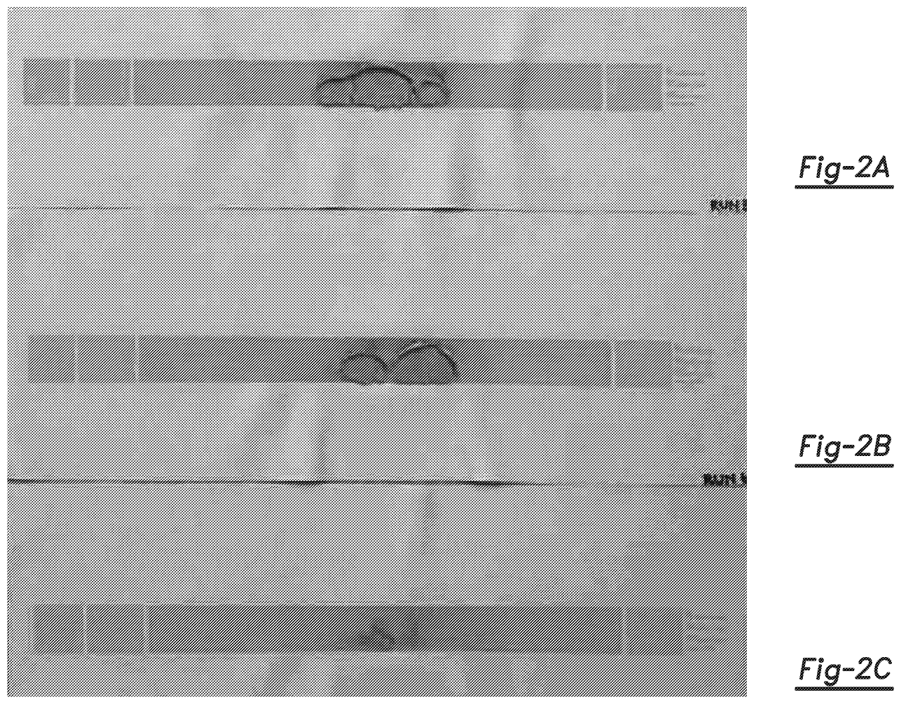

Color photographs of each of prints exposed to 9.93 J/cm² of UV energy were taken after energy exposure. The photographs are reproduced in black and white in FIG. 2A through FIG. 2C. The print generated with the comp. ink after exposure to 9.93 J/cm² of UV energy is shown in FIG. 2A; the print generated with ex. ink 2 after exposure to 9.93 J/cm² of UV energy is shown in FIG. 2B; and the print generated with ex. ink 1 after exposure to 9.93 J/cm² of UV energy is shown in FIG. 2C. FIG. 2A through FIG. 2C illustrate that the presence of the additive reduces heat damage to the printed polyester substrate.

Optical Density

The initial optical density (initial OD) of each of the prints exposed to 6.62 J/cm² of UV energy (i.e., the print generated with ex. ink 1, the print generated with ex. ink 2, and the print generated with the comp. ink) was measured. Then, the prints were washed 5 times in a Kenmore 90 Series Washer (Model 110.289 227 91) with warm water (at about 40° C.) and detergent. Each print was allowed to air dry between each wash. Then, the optical density (OD after 5 washes) of each print was measured, and the percent change in optical density (%Δ OD) was calculated for each print.

As examples, an initial optical density greater than 1.0 is a good initial optical density for a print, and a percent change in optical density of less than 10% after 5 washes is a good optical density percent change for a print.

The initial optical density (initial OD), the optical density after 5 washes (OD after 5 washes), and the percent change in optical density (%Δ in OD) of each print exposed to 6.62 J/cm² of UV energy are shown in Table 3. In Table 3, each print is identified by the ink composition used to generate the print.

TABLE 3

| Ink composition used | Initial | OD after | Δ OD |
|---|---|---|---|
| to generate the print | OD | 5 washes | (%) |
| Comp. ink | 1.528 | 1.494 | −2.23 |
| Ex. ink 1 | 1.535 | 1.476 | −3.84 |
| Ex. ink 2 | 1.489 | 1.407 | −5.51 |

As shown in Table 3, each print generated with the example inks had an initial optical density and an optical density after 5 washes greater than 1.4. Thus, the results shown in Table 3 indicate that the prints generated on polyester with the example inks and exposed to 6.62 J/cm² of UV energy had good initial optical density and good optical density after 5 washes.

As also shown in Table 3, the change in optical density was less than 6% for each print generated with the example inks. Thus, the results shown in Table 3 indicate that the prints generated on polyester with the example inks and exposed to 6.62 J/cm² of UV energy had an acceptable change in optical density and acceptable washfastness.

The results in this example illustrate that the energy dissipating additive can reduce the degradation to the textile fabric when used with dye sublimation dyes that are highly absorbing of UV radiation used to initiate sublimation without deleteriously affecting the optical density of the print.

It is to be understood that the ranges provided herein include the stated range and any value or sub-range within the stated range, as if such values or sub-ranges were explicitly recited. For example, from about 360 nm to about 410 nm should be interpreted to include not only the explicitly recited limits of from about 360 nm to about 410 nm, but also to include individual values, such as about 368.5 nm, about 379.75 nm, about 384.67 nm, about 397.0 nm, about 405.2 nm, etc., and sub-ranges, such as from about 366.53 nm to about 382.5 nm, from about 380.25 nm to about 396.2 nm, from about 391.75 nm to about 408.79 nm, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A dye sublimation inkjet ink set, comprising:
(i) a first dye sublimation inkjet ink including:
a first disperse dye colorant dispersion including a first disperse dye having absorption at a radiation wavelength ranging from about 360 nm to about 410 nm;
an additive to absorb energy at the radiation wavelength ranging from about 360 nm to about 410 nm and to dissipate at least some of the absorbed energy as fluorescence, the additive being selected from the group consisting of a compound containing from 3 to 5 fused benzene rings and a coumarin derivative;
a first co-solvent; and
a balance of water; and
(ii) a second dye sublimation inkjet ink including:
a second disperse dye colorant dispersion including a second disperse dye having less absorption at the radiation wavelength than the first disperse dye;
a second co-solvent; and
a balance of water.

2. The dye sublimation inkjet ink set as defined in claim 1 wherein:
a fluorescence lifetime of the compound containing from 3 to 5 fused benzene rings is less than 20 ns in cyclohexane; or
a fluorescence lifetime of the coumarin derivative is less than 20 ns in polymethylmethacrylate.

3. The dye sublimation inkjet ink set as defined in claim 1 wherein:
a fluorescence yield of the compound containing from 3 to 5 fused benzene rings is greater than 0.5 in cyclohexane; or
a fluorescence yield of the coumarin derivative is greater than 0.7 in polymethylmethacrylate.

4. The dye sublimation inkjet ink set as defined in claim 1 wherein the additive is the compound containing from 3 to 5 fused benzene rings, and wherein the compound containing from 3 to 5 fused benzene rings is selected from the group consisting of 9,10-diphenylanthracene, 9-(p-vinylphenyl)-10-phenylanthracene, 9,10-bis(phenylethynyl)anthracene, 1,3,6,8-tetraphenylpyrene, 10-ethoxybenzoxanthene, pyrene, perylene, chrysene, and combinations thereof.

5. The dye sublimation inkjet ink set as defined in claim 1 wherein the additive is the coumarin derivative, and wherein the coumarin derivative is selected from the group consisting of 7-dialkylamino-3-carbaldehyde coumarin and 7-diarylamino-3-caraldehyde coumarin.

6. The dye sublimation inkjet ink set as defined in claim 1 wherein:
the first dye sublimation inkjet ink is a yellow dye sublimation inkjet ink or a black dye sublimation inkjet ink; and
the second dye sublimation inkjet ink is a cyan dye sublimation inkjet ink or a magenta dye sublimation inkjet ink.

7. The dye sublimation inkjet ink set as defined in claim 1 wherein the additive is present in the first dye sublimation inkjet ink in amount ranging from about 0.025 wt % to about 2.0 wt % of a total weight of the first dye sublimation inkjet ink.

8. The dye sublimation inkjet ink set as defined in claim 7 wherein the second dye sublimation inkjet ink excludes the additive in the first dye sublimation inkjet ink.

9. A textile printing kit, comprising:
a textile fabric; and
a dye sublimation inkjet ink including:
a first disperse dye colorant dispersion including a first disperse dye having absorption at a radiation wavelength ranging from about 360 nm to about 410 nm;
an additive to absorb energy at the radiation wavelength ranging from about 360 nm to about 410 nm and to dissipate at least some of the absorbed energy as fluorescence, the additive being selected from the group consisting of a compound containing from 3 to 5 fused benzene rings and a coumarin derivative;
a co-solvent; and
a balance of water.

10. The textile printing kit as defined in claim 9, further comprising a second dye sublimation inkjet ink including:
a second disperse dye colorant dispersion including a second disperse dye having less absorption at the radiation wavelength than the first disperse dye;
a second co-solvent; and
a balance of water.

11. The textile printing kit as defined in claim 10 wherein:
the first dye sublimation inkjet ink is a yellow dye sublimation inkjet ink or a black dye sublimation inkjet ink; and
the second dye sublimation inkjet ink is a cyan dye sublimation inkjet ink or a magenta dye sublimation inkjet ink.

12. A printing method, comprising:
generating a print by inkjet printing a dye sublimation inkjet ink directly onto a textile substrate, the dye sublimation inkjet ink including:
a first disperse dye colorant dispersion including a first disperse dye having absorption at a radiation wavelength ranging from about 360 nm to about 410 nm;
an additive to absorb energy at the radiation wavelength ranging from about 360 nm to about 410 nm and to dissipate at least some of the absorbed energy as fluorescence, the additive being selected from the group consisting of a compound containing from 3 to 5 fused benzene rings and a coumarin derivative;
a co-solvent; and
a balance of water; and
exposing the print to electromagnetic radiation having a wavelength ranging from about 360 nm to about 410 nm.

13. The printing method as defined in claim 12 wherein:
the generating of the print further includes inkjet printing a second dye sublimation inkjet ink directly onto the textile substrate; and
the second dye sublimation inkjet ink includes:
a second disperse dye colorant dispersion including a second disperse dye having less absorption at the radiation wavelength than the first disperse dye;
a second co-solvent; and
a balance of water.

14. The printing method as defined in claim 13 wherein the first dye sublimation inkjet ink and the second dye sublimation inkjet ink are exposed to the electromagnetic radiation simultaneously.

15. The printing method as defined in claim 12 wherein:
the exposing of the print to electromagnetic radiation is for a time period ranging from about 0.1 sec to about 5 sec; and
the electromagnetic radiation results in an energy exposure ranging from about 0.5 J/cm² to about 20 J/cm².
